(19) United States
(12) Patent Application Publication
(10) Pub. No.: US 2026/0105133 A1
(43) Pub. Date: Apr. 16, 2026

(54) System and method for certifying email and verifying email correspondence

(71) Applicant: Joe L. Ruiz, San Jose, CA (US)

(72) Inventor: Joe L. Ruiz, San Jose, CA (US)

(21) Appl. No.: 18/918,045

(22) Filed: Oct. 16, 2024

(51) Int. Cl. G06F 21/31

(52) U.S. Cl. CPC G06F 21/31

(57) ABSTRACT

The invention introduces a system designed to certify the authenticity of email correspondence. It works by first allowing users to authorize access to their email accounts, after which specific email threads are selected for verification. The system employs a verification module to authenticate various email attributes, ensuring that the content remains accurate and untampered. Once verified, users can certify the email correspondence using a certification module, which securely stores the data. A key feature of the system is its use of blockchain technology to guarantee the immutability of the data. Additionally, a certificate generation module produces Certificates of Correspondence, which automatically update as new messages are added through a “Live Certificates” feature. Authorized users can easily access the latest certificate through a scannable link.

### CROSS-REFERENCE TO RELATED APPLICATIONS

This application claims the benefit of U.S. Provisional Patent Application No. #63/544,288, filed Oct. 16, 2024 which is incorporated by reference herein in its entirety.

### FIELD OF THE INVENTION

The present invention relates to systems and methods for certifying email and verifying email correspondence, particularly to ensuring the authenticity, integrity, and security of email communications using blockchain technology.

### BACKGROUND OF THE INVENTION

Email communication has become an essential tool for personal, professional, and legal interactions. However, existing systems for verifying the authenticity of email communication suffer from significant limitations, including susceptibility to tampering, phishing, and email spoofing. Current solutions, such as digital signatures and Public Key Infrastructure (PKI), are complex to implement, require specialized knowledge, and rely on centralized authorities. Additionally, many of these systems lack the ability to provide real-time certification for evolving email threads or ensure data integrity without transmitting sensitive information to third-party servers. Given the widespread reliance on email for critical business operations, legal processes, and financial transactions, there is a need for a robust, user-friendly solution that can certify email authenticity in real time while ensuring privacy and data integrity.

In the field of personal communication, email serves as a lifeline that transcends geographical barriers, allowing friends and family to stay in touch regardless of physical distance. It offers a versatile platform for sharing personal updates, photos, and heartfelt messages. Moreover, it has become the default method for organizing events, planning vacations, and coordinating social activities.

However, the impact of email extends far beyond the realm of personal interactions. It has permeated the fabric of the business world, playing a pivotal role in facilitating critical operations. Emails are used for conducting negotiations, sealing deals, exchanging contracts, and managing important documentation. They serve as a virtual conference room, a document repository, and a communication channel all in one. Furthermore, email is an essential component of organizational processes, from customer service and marketing to project management and internal communication.

Yet, amid this widespread reliance on email, a persistent concern remains: ensuring the authenticity and integrity of email messages. This concern is particularly pronounced in specific contexts where the stakes are high and the implications of an email's authenticity hold significant weight.

In legal proceedings, email correspondence is increasingly used as evidence. Attorneys rely on email records to support or challenge legal claims. A single email can have profound implications in contract disputes, intellectual property cases, or even criminal investigations. However, the trustworthiness of email evidence is often brought into question, with issues ranging from email tampering to identity impersonation.

Business transactions, too, are profoundly affected by the authenticity of email. When financial transactions, such as fund transfers, rely on email communication, the validity of the communication is of paramount importance. Unauthorized alterations to email content, fraud, or disputes over the terms of agreements can lead to significant financial losses.

Email communication, while ubiquitous and convenient, faces a range of vulnerabilities that pose substantial risks. Phishing attacks, for instance, involve deceptive emails that aim to trick recipients into disclosing sensitive information or engaging in harmful actions. Email spoofing is another concern, where malicious actors disguise their identity, making it difficult to discern legitimate senders from impostors. Moreover, the alteration of email content during transmission can lead to misunderstandings or create opportunities for cyberattacks, potentially jeopardizing data security and privacy. In legal and regulatory scenarios, these issues are further compounded, as the burden of proving the authenticity of email correspondence can be challenging, potentially affecting the outcome of disputes or compliance matters. Hence, the demand for dependable email certification mechanisms has surged as an imperative need, seeking to mitigate these risks and establish trust in email communications across personal, professional, and legal domains.

Several methods have been developed to address the authenticity of email correspondence. These include digital signatures, public key infrastructure (PKI), and the use of secure email gateways. While these methods have provided some degree of authentication, they come with their own set of challenges. For instance, PKI solutions often require complex setups and management, making them less accessible for everyday users.

Digital signatures are a widely used approach to verifying email authenticity. However, their effectiveness depends on key management, and they may not be universally accepted or implemented across all email platforms. Additionally, the reliance on a centralized certificate authority raises concerns about single points of failure.

Secure email gateways can filter and analyze emails for authenticity, but they may suffer from false positives and false negatives, potentially resulting in legitimate emails being classified as spam or malicious emails slipping through the cracks. Furthermore, these gateways require significant processing resources, which can be costly and lead to performance issues.

A significant challenge in the realm of email authentication is interoperability. Email systems are diverse, with users employing various email providers and client applications. This diversity creates difficulties in achieving a standardized, universal solution for email authentication. Many existing authentication methods are complex, requiring users to undergo intricate setup procedures. The complexity of these methods often deters users from implementing them consistently, thus undermining their effectiveness.

The absence of immutable records of email correspondence is a pivotal issue plaguing existing systems and methods for email verification and certification. The crux of this problem lies in the vulnerability of email content to tampering, alterations, or unauthorized modifications. In contexts that demand the highest standards of authenticity, such as legal and regulatory proceedings, this deficiency becomes particularly critical. The inability to establish a tamper-proof trail of email communication can create significant obstacles, as parties may dispute the veracity of email content, leading to challenges in providing conclusive evidence.

In the absence of such immutable records, proving the legitimacy and unaltered nature of email correspondence can be an arduous task. This problem compromises the reliability and trustworthiness of email evidence, making it challenging to meet the stringent requirements of legal and regulatory standards. Consequently, a pressing need exists for a solution that can rectify this shortcoming, ensuring that email correspondence can be authenticated and certified with an immutable record, thereby enhancing its probative value and reinforcing the integrity of email-based communication in critical and sensitive domains.

Some existing solutions do not adequately address the dynamics of email threads. Email threads can evolve, and new messages may be added. Some existing methods may encounter difficulties when updating and certifying the evolving content of email threads in real-time, particularly when handling complex, multi-message threads or dynamic changes that require continuous certification updates.

The cost associated with implementing and maintaining existing email authentication systems can be prohibitive for many individuals and small businesses. These costs include hardware, software, and ongoing management expenses.

Existing systems for email correspondence certification often fall short in two critical aspects. Firstly, they lack the capacity to offer real-time monitoring and updates to email threads, which presents a notable challenge in maintaining the integrity and certification of email content over time. The absence of real-time monitoring means that changes, additions, or modifications to email threads may not be promptly captured and certified. This gap is particularly significant in scenarios where the timeliness and accuracy of email records are crucial. For instance, in legal cases, disputes, or investigations, the inability to continuously verify and update email threads can compromise the ability to establish the authenticity of email correspondence.

Secondly, many current methods rely on transmitting sensitive email data to third-party servers. This approach, while sometimes necessary for certification and verification, raises considerable concerns about the privacy and security of email content and user information. Sending email data to external servers can expose it to potential security breaches or unauthorized access, posing a risk to the confidentiality of the communication. Additionally, it may also involve trusting third-party entities with sensitive information, which may not align with the security and privacy standards demanded by individuals, organizations, or legal and regulatory requirements.

In light of these challenges, there is a clear imperative for an innovative solution that addresses these shortcomings. Such a solution should offer real-time monitoring and updates to email correspondence, ensuring that email threads remain certified and unaltered over time. Moreover, it should address the privacy and security concerns related to transmitting sensitive email data to external servers. The invention introduced in this patent specification endeavors to meet these requirements, enhancing the robustness, privacy, and security of email certification and verification processes.

In light of the challenges posed by existing systems and methods for certifying the authenticity of email correspondence, there is a pressing need for a comprehensive solution that addresses these limitations and provides users with a reliable, user-friendly, and cost-effective approach to certifying email authenticity.

### SUMMARY OF THE INVENTION

This summary is provided to introduce a selection of concepts in a simplified format that are further described in the detailed description of the present disclosure. This summary is not intended to identify key or essential inventive concepts of the present disclosure, nor is it intended for determining the scope of the present disclosure.

The present invention provides a comprehensive system for certifying and verifying email correspondence using real-time monitoring and blockchain technology. The system includes a user authorization module, a verification module for authenticating email attributes, a certification module, and a blockchain module that ensures data immutability. A key feature of the invention is the generation of “Live Certificates,” which automatically update when new emails are added to an email thread. The system addresses existing problems by providing real-time updates through cryptographic verification processes, ensuring privacy through encryption methods such as AES-256 and ensuring the security of the certification data with blockchain immutability, preventing any unauthorized alterations of email exchanges.

Another objective of the present invention is to provide an improved system and method which offers real-time monitoring and updates for email threads.

Another objective of the present invention is to safeguard the privacy and security of email content and user information.

Another objective of the present invention is to simplify the process of certifying email correspondence, making it accessible and user-friendly.

An aspect of the present invention provides an improved system and method for certifying the authenticity of email correspondence. By offering a solution that overcomes the complexities, costs, and interoperability challenges associated with existing systems, this invention aims to enhance the reliability and trustworthiness of email communication while ensuring the creation of immutable records of email correspondence.

In an embodiment, the invention provides a system for certifying the authenticity of email correspondence comprises a user authorization module for obtaining authorization to access the user's email account, a user interface module allowing email thread selection, a verification module to authenticate email attributes, a certification module for user-driven certification and data storage, a blockchain module to ensure data immutability, a certificate generation module to create Certificates of Correspondence and record them on the blockchain, “Live Certificates” functionality for automatic certificate updates, and a user access module enabling authorized users to access the most recent valid certificate through a scannable online link.

In an another embodiment, the invention provides a method for certifying the authenticity of email correspondence that involves a series of steps, including obtaining user authorization to access their email account, enabling the user to select an email thread for verification, authenticating email attributes, facilitating user-driven certification and data storage, ensuring data immutability through blockchain technology, generating Certificates of Correspondence, automatically updating certificates with “Live Certificates” functionality, and providing authorized users with access to the most recent valid certificate through a scannable online link.

To further clarify the advantages and features of the present disclosure, a more particular description of the disclosure will be rendered by reference to specific embodiments thereof, which is illustrated in the appended. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 Illustrates a flowchart of a method for certifying email and verifying email correspondence, in accordance with an embodiment of the present disclosure.

FIG. 2 Illustrates a block diagram of a system for certifying email and verifying email correspondence, in accordance with an embodiment of the present disclosure.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The term “some” as used herein is to be understood as “none or one or more than one or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments, without departing from the scope of the present disclosure.

The present invention discloses a comprehensive system which is designed to offer a multifaceted approach to email certification, addressing the critical aspects of user authorization, email thread selection, verification, data storage, and accessibility.

### System Overview

The system is designed to provide a seamless, user-friendly method for verifying the authenticity of email correspondence in real time, ensuring that email messages remain tamper-proof. The system includes multiple modules that work together to certify email correspondence, store it immutably on a blockchain, and generate updated certificates as needed.

### User Authorization Module

This module plays a pivotal role by securing permission from users to access their email accounts hosted by various service providers. This initial step is crucial to establish trust and enable the system to operate effectively. The user interface module further enhances the user experience, allowing for seamless email thread selection, ensuring that users can easily designate which email exchanges they wish to verify and certify as authentic.

### Verification Module

The verification module authenticates key email attributes to ensure that the correspondence is genuine. This includes verifying the Message ID, From and To fields, Subject, Date, and SPF (Sender Policy Framework) and DKIM (DomainKeys Identified Mail) headers. SPF and DKIM help confirm that the email originates from a trusted source and has not been altered during transmission. This comprehensive scrutiny ensures the email's legitimacy and safeguards against potential tampering. The certification module empowers users, putting them in control of the certification process while securely storing data files, which can include messages, Mime reports, and attachments.

### Certification Module

Upon successful verification, the certification module certifies the email correspondence. This involves securely storing the email messages, MIME data, and attachments. The certification module applies encryption to ensure that sensitive information is protected. All certified data is stored in a secure database. The certificate generation module creates Certificates of Correspondence that reflect the authenticity and security of the email thread. These certificates are stored on the blockchain and are automatically updated whenever new messages are added to the thread. This allows the certificate to remain current and valid over time. The certification module empowers users, putting them in control of the certification process while securely storing data files, which can include messages, Mime reports, and attachments.

### Blockchain Module

The blockchain module is responsible for ensuring the immutability of the certified data. Once an email thread is certified, the data is hashed and recorded on a blockchain. This prevents tampering by ensuring that the certification record is cryptographically linked to the blockchain's immutable ledger. The blockchain module timestamps every certification event, creating a verifiable history of the correspondence.

### Certificate Generation Module

The certificate generation module creates Certificates of Correspondence that reflect the authenticity and security of the email thread. These certificates are stored on the blockchain and are automatically updated whenever new messages are added to the thread. This allows the certificate to remain current and valid over time. Further, the system introduces “Live Certificates” functionality, a dynamic feature that enables the automatic generation of new certificates and the voiding of existing ones when new email messages are added to the thread. This real-time update capability ensures that the certification remains current and reflective of the email's status. Lastly, a user access module provides authorized users with the convenience of accessing the most recent valid certificate through a scannable online link, making the certification process user-friendly and accessible.

### User Access Module

This module allows authorized users to access the most recent certificate of an email thread. The system generates a scannable link (e.g., QR code) that provides users with instant access to the most recent certificate, ensuring that users can verify the authenticity of an email at any time

The disclosed system introduces a robust mechanism to authenticate and certify entire email correspondences, often referred to as email threads, along with their accompanying attachments. This capability addresses critical aspects of email communication, enhancing trust and reliability in digital exchanges.

The primary objective of the system is to provide a comprehensive certification process, ensuring that the entire email thread and its associated attachments are deemed authentic and secure. This process begins by systematically verifying the sender's and recipient's email addresses involved in the email conversation. By validating these addresses, the system confirms that the email messages have indeed been sent and received by the intended parties. This verification of email addresses is crucial in establishing the legitimacy of the correspondence, as it mitigates the risk of email spoofing and fraudulent emails.

In addition to verifying email addresses, the system meticulously examines the timing aspects of the email thread. It authenticates the exact times when each message within the thread was sent and when it was delivered to the respective recipients. This verification is essential for establishing the chronological order and integrity of the email exchange, which is particularly important in scenarios where the sequence of messages is of legal or operational significance.

Furthermore, the system extends its verification process to encompass the attachments included within the email thread. It scrutinizes these attachments, confirming their authenticity and ensuring that they have not been tampered with or altered in any way. This validation of attachments is essential in specific contexts such as business transactions or legal proceedings, where ensuring the unaltered integrity of attached documents is critical for compliance and legal integrity.

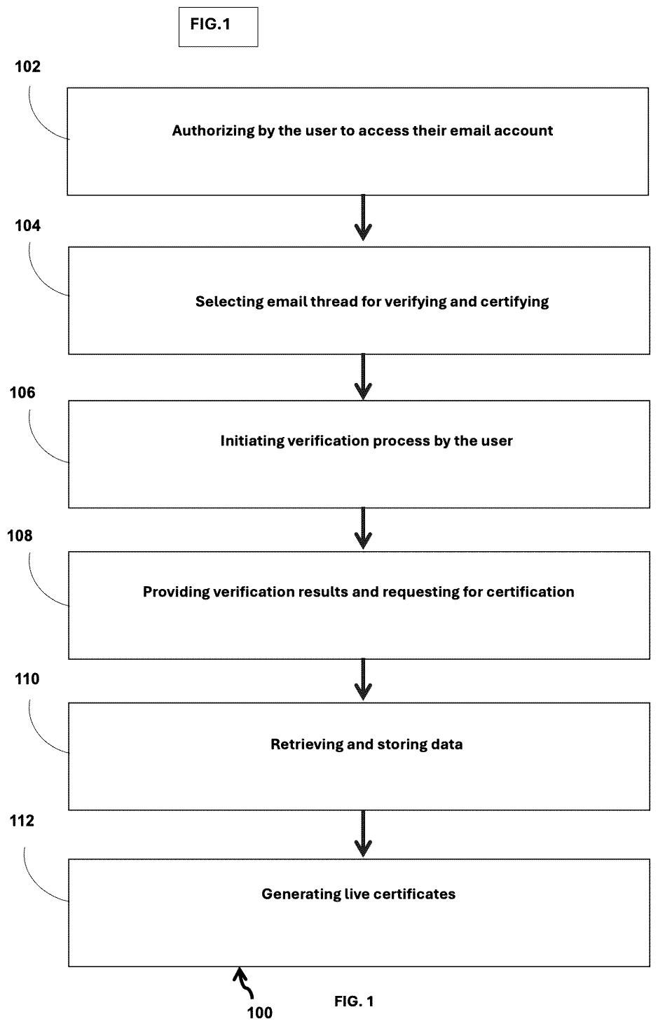

In accordance with an embodiment of the present invention, FIG. 1 illustrates a flowchart of the method 100 for certifying email and verifying email correspondence. The method initiates with the crucial step of user authorization 102. The user grants the system permission to access their email account, signifying the starting point of the process. Following authorization, the user is presented with the choice to select 104 a specific email thread that they wish to have verified and certified as authentic. This step empowers the user to prioritize which email exchanges are subject to verification. After the email thread selection, the user takes an active role in initiating 106 the verification process. The system responds to the user's request to verify the chosen email correspondence. This step marks the beginning of the rigorous authentication and verification procedures.

Once the verification process is completed, the system provides 108 the user with the verification result. The result falls into one of three categories: “Verified,” “Verified with Issues,” or “Verification Failed.” Depending on this result, the user decides whether to proceed with certification or not. This step is pivotal, as it gives the user full control over the certification process. Further, if the user is satisfied with the verification status and chooses to certify the email correspondence, the system proceeds to retrieve and store 110 copies of all data files within the email thread. This includes the messages, Mime reports, and any attachments. These copies are then securely stored, time-stamped, encrypted, and cryptographically recorded, ensuring their immutability. Further, the method encompasses the generation 112 of certificates of correspondence. The first certificate is created and recorded on the blockchain, and if new messages are added to the email thread over time, the system automatically generates new certificates. These live certificates are also time-stamped and added to the blockchain, thereby providing a dynamic and real-time record of the email correspondence's authenticity.

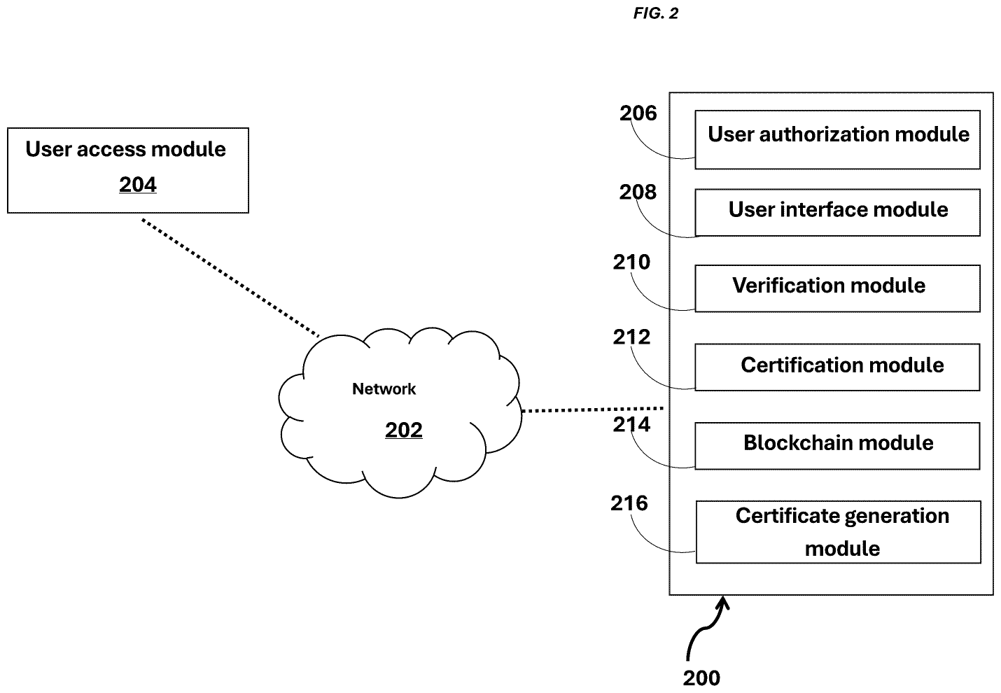

In accordance with an embodiment of the present invention, FIG. 2 illustrates a block diagram of a system 200 for certifying email and verifying email correspondence. This figure shows a network 202 in connection with various modules of the disclosed system 200. At the core of the system is the user authorization module 202, which plays a pivotal role in obtaining user authorization to access their email account. This module interfaces with various email service providers, enabling user authentication and access. The user interface module 208 allows users to interact with the system, facilitating the selection of specific email threads for verification and certification. Once the user selects an email thread, the verification module 210 comes into play. This component is responsible for authenticating various email attributes, including critical elements like Message ID, Date, From, To, subject, and the authentication of SPF and DKIM headers. It assesses the integrity and authenticity of the selected email correspondence.

Further, upon successful verification, the certification module 212 empowers users to certify the email correspondence, indicating its authenticity and security. This step initiates the process of retrieving and storing data files within the email thread. The blockchain module 214 seamlessly integrates blockchain technology to ensure secure, time-stamped, and encrypted data storage, guaranteeing the immutability of the certified content. The certificate generation module 216 is responsible for generating Certificates of Correspondence, which are recorded on the blockchain, providing a transparent and tamper-proof record of the certification event. The dynamic “Live Certificates Functionality” ensures that new certificates are automatically generated and added to the blockchain when new messages are introduced into the email thread, offering real-time updates. Finally, the user access module 204 caters to authorized users, granting them access to the most recent valid certificate. This feature enables users to conveniently view and verify email correspondences online, thus completing the cycle of the system's email certification and verification process.

As discussed above, the working of the system begins with the crucial step of user authorization. The user grants the system permission to access their email account, typically by providing the necessary login credentials or authorization keys. Importantly, the system is designed to be compatible with email accounts from a wide array of service providers, ensuring that it can seamlessly interact with accounts hosted by major email providers such as Microsoft or Google. This versatility is integral to the system's ability to cater to a diverse user base with varying email service preferences.

Once the system gains access to the user's email account, it proceeds to the next stage of the process, where the user takes an active role. At this juncture, the user is presented with the option to select a specific email thread, often referred to as a “Correspondence,” that they wish to subject to the system's verification and certification process. This selection is pivotal as it allows the user to exercise control over which email exchanges they deem important to validate as authentic.

The user's decision to choose a particular email thread for verification and certification can be influenced by various factors. For instance, in a legal context, the user may select a thread containing contractual agreements or crucial evidence. In a business context, it could involve the certification of communication-related to a major transaction. In a personal context, it might be a means to ensure the authenticity of significant exchanges. The flexibility of user selection empowers the user to prioritize which email threads hold the most substantial significance and warrant rigorous verification.

The process of verifying an email thread within the system is designed to be meticulous and thorough, ensuring that the email correspondence can be certified as authentic with a high degree of confidence. The verification process commences at the user's discretion. The system provides the user with the option to verify the email correspondence before proceeding to generate a certificate. This user-driven approach ensures that verification is carried out when the user deems it necessary, adding a layer of flexibility and control to the process. Upon the user's request to verify the email thread, the system takes the next step. It sends an electronic request to the user's email service provider, specifically seeking a copy of the Mime File of the original email. This original email, often the first one sent, serves as the basis for the entire email thread and is critical in establishing the correspondence's authenticity.

The system then meticulously authenticates various attributes of the email correspondence. This authentication process involves a comprehensive examination of key elements, including the Message ID, Date, From (sender), To (recipients), Subject, and the Authentication of SPF (Sender Policy Framework) and DKIM (DomainKeys Identified Mail) headers. The SPF and DKIM authentication mechanisms are fundamental for verifying the legitimacy of the email's sources and ensuring that the email has not been tampered with. This flexibility of user selection empowers the user to prioritize which email threads hold significant importance and warrant rigorous verification. Depending on the outcomes of SPF and DKIM authentication, the system categorizes the verification results into ‘Verified,’ ‘Verified with Issues,’ or ‘Verification Failed,’ where each result prompts specific actions such as revalidation, user alerts, or the halting of the certification process, ensuring precise handling of discrepancies or incomplete verifications. Results are conveyed to the user and fall into one of three categories:
Verified: If the SPF and DKIM authentication processes confirm the authenticity of the email attributes, the system returns a “Verified” status, indicating that the email correspondence is genuine and unaltered.
Verified with Issues: In the cases where there are minor discrepancies or issues with the authentication results, the system may return a “Verified with Issues” status, alerting the user to potential concerns while still acknowledging the overall authenticity of the email.
Verification Failed: If the SPF and DKIM authentication processes detect significant discrepancies or authentication failures, the system returns a “Verification Failed” status, indicating that the email correspondence could not be certified as authentic.

Along with the verification result, the system provides the user with a summary of the email thread. This summary includes crucial information such as the date and time of the first message sent in the thread, as well as the date and time of the last message in the thread. It also outlines the number of participants involved in the thread, the quantity of attachments included, and the total file size of the data files within the email thread. This summary offers a comprehensive snapshot of the email correspondence's key attributes, providing additional context for the user's decision-making process.

In an embodiment, the process of certifying an email correspondence within the system is the final step in ensuring the authenticity and security of the communication. The process commences with the user having full control and discretion. After the verification of the email correspondence, the user assesses the verification status. If the user is satisfied with the verification results, indicating that the email correspondence has been deemed authentic and secure, they are presented with the option to proceed with certification.

Upon choosing the “certify” option, the system initiates a series of steps to ensure the email correspondence is securely certified. This step is pivotal, as it indicates the user's confidence in the authenticity and integrity of the email thread.

The first action taken by the system when the user selects the “certify” option is the retrieval of copies of all data files within the email thread. These data files encompass not only the email messages but also the associated Mime reports and attachments. The system accesses this data directly from the user's email account, ensuring that the certified copies reflect the precise content of the correspondence.

After pulling the necessary data files, the system securely stores these copies on dedicated server of the system. This storage process is characterized by several key security measures:
Time-Stamping: Each data file is time-stamped, creating a chronological record of when the data was certified and stored. This time-stamping adds an additional layer of security and transparency to the certification process.
Encryption: The data files are encrypted, protecting them from unauthorized access or tampering. Encryption ensures that the content remains confidential and secure throughout its storage on the system's servers.
Blockchain Record: Perhaps the most critical security measure is the cryptographic recording of the data files on the system's blockchain. The blockchain technology ensures that once the data files are recorded, they become immutable. This means that they cannot be altered or tampered with by any participants in the email thread or by any third parties seeking access to the data. The blockchain's distributed and transparent nature adds an unprecedented level of security and trustworthiness to the certified email correspondence.

In an embodiment, the concept of “Live Certificates” in the disclosed system is a dynamic and innovative feature that plays a pivotal role in ensuring the continuous and up-to-date certification of email correspondences. When a user initiates the certification process for an email correspondence, the system generates the first Certificate of Correspondence. This certificate is a digital record that encapsulates the authentication and certification status of the entire email thread, including its various attributes and attachments. This initial certificate is time-stamped, ensuring that it reflects the precise moment of its creation. Once generated, the Certificate of Correspondence is securely recorded on the blockchain. The blockchain serves as a decentralized and immutable ledger, providing an indelible and transparent record of the certification event. This blockchain recording offers a high level of security and trust, ensuring that the certificate cannot be tampered with or altered by any party.

The uniqueness of the Live Certificates feature becomes evident when the email thread is updated. In the case of new messages being added to the email thread, the system continuously monitors the conversation. This monitoring is particularly valuable in contexts where the email correspondence is subject to changes over time, such as ongoing legal or business discussions. Upon detecting a new message within the thread, the system automatically triggers the generation of a new Certificate of Correspondence. This certificate is a snapshot of the email correspondence at the moment of the new message's inclusion. Like the initial certificate, this new certificate is time-stamped to reflect its creation time accurately.

The newly generated certificate is also recorded on the blockchain. This addition to the blockchain ensures that there is an immutable and chronological record of all certificates generated throughout the email correspondence's evolution. The Live Certificates feature ensures full disclosure of all data within the email thread. Users can refer to the blockchain to access the complete history of certificates, each representing the state of the email correspondence at specific points in time. This transparency enables users to track the evolution of the email thread, observe any changes or updates, and verify the authenticity of the correspondence at any given moment.

Live Certificates offer a dynamic and real-time certification process that adapts to the evolving nature of email correspondences. It guarantees that the email thread's certification remains current and accurately reflects its status, even as new messages are added over time. This feature is instrumental in maintaining the trustworthiness and security of email communication, especially in contexts where the email content may undergo changes that need to be certified and documented.

In an embodiment, the system provides users with a valuable feature that enables them to proactively request the system to track and record an email thread before proceeding with the certification process. This functionality empowers users with the ability to maintain a comprehensive and real-time record of their email correspondences, offering a layer of protection and trust even before formal certification is initiated.

This capability is particularly advantageous in situations where users anticipate the need for future validation or where they want to ensure the integrity of email threads from their inception. By choosing to track and record an email thread prior to certification, users are essentially creating a continuous log of their communication history, which can serve various purposes. For instance, it can be pivotal in legal contexts, providing a verifiable record of communications for litigation or dispute resolution. In business settings, it can enhance transparency and accountability, facilitating contractual compliance and operational efficiency.

Moreover, the ability to track and record an email thread prior to certification aligns with the broader philosophy of preserving the authenticity and security of digital communication. It is a proactive approach that acknowledges the evolving nature of email exchanges and the importance of maintaining a reliable record for various professional, legal, or personal needs. Users can leverage this feature to strengthen their email communication's credibility and ensure that their correspondence remains trustworthy and verifiable over time.

Some of the non-limiting advantages of the present invention are:
The system significantly enhances the trustworthiness of email correspondence by offering a comprehensive verification and certification process. Users can rely on the authenticity of their email exchanges, making it particularly valuable in legal, business, and sensitive personal communication.
The utilization of blockchain technology ensures that certified email correspondences are immutable and tamper-proof. This provides a robust and transparent mechanism for verifying the authenticity and integrity of email threads, even in the face of potential disputes.
The “Live Certificates” feature offers real-time certification updates. As email threads evolve with new messages, the system automatically generates fresh certificates, maintaining the trustworthiness of email conversations without the need for manual intervention.
Users have the option to proactively track and record email threads before certification. This pre-emptive feature provides an invaluable record of communications from their inception, offering transparency, legal protection, and accountability.
The system's ability to access email accounts from various service providers, including major platforms like Microsoft and Google, ensures its versatility and accessibility for a broad user base, enhancing its utility in diverse contexts.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible

1. A system for certifying the authenticity of email correspondence, comprising:
A user authorization module (206) programmed to obtain authorization to access a user's email account.
A verification module (210) programmed to authenticate email attributes, including Message ID, SPF (Sender Policy Framework), and DKIM (DomainKeys Identified Mail) headers;
A certification module (212) programmed to generate a Certificate of Correspondence by securely storing email messages, metadata, and attachments;
A blockchain module (214) programmed to ensure data immutability by cryptographically recording the Certificate of Correspondence on a decentralized blockchain;
A certificate generation module (216) programmed to automatically update the Certificate of Correspondence when new messages are added to an email thread, with each update being cryptographically recorded on the blockchain;
A user access module (204) programmed to grant authorized users to the most up-to-date valid Certificate of Correspondence through a scannable link or alternatively, a public or private key, or other unique identifier.

1. The system of claim 1, wherein the verification module (210) further comprises :
A process to verify sender identity, ensure accurate timestamps, while maintaining the integrity of the email chain to prevent any alterations or tampering of the certified email content.

2. The system of claim 1, wherein the blockchain module (214) is decentralized and does not rely on a centralized server, ensuring that the certificate's record is distributed across multiple nodes for enhanced security and integrity.
